(19) United States
(12) Patent Application Publication
(10) Pub. No.: US 2005/0044220 A1
(43) Pub. Date: Feb. 24, 2005

(54) Method and system of managing computing resources

(76) Inventor: Sajeev Madhavan, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/635,741

(22) Filed: Aug. 5, 2003

(51) Int. Cl. G06F 15/173

(52) U.S. Cl. 709/225

(57) ABSTRACT

The invention, in one embodiment, is a computing resource management method comprising: establishing a pool of free computing resources in a computing system; selecting a free computing resource from the pool of free computing resources to replace an operating computing resource in the computing system; and configuring the selected free computing resource to operate in the computing system, after replacing the operating computing resource with the free computing resource in the computing system, wherein said free computing resources comprises resources not preconfigured for use in said computing system. In alternative embodiments, the invention pertains to a computing resource management system, and a computer-useable storage media embodying aspects of the computing resource management method.

### FIELD OF THE INVENTION

Embodiments of the present invention pertain to a method, a system and a computer-useable storage medium for managing computing resources in a computing system.

### BACKGROUND OF THE INVENTION

In large-scale computing systems, pools of computing resources are provided to serve end-users' needs. A computing resource pool is a collection of hardware and software computing resources, e.g., servers, routers, data storage systems, load balancers, central processing units and the like (“resources”) for use in data processing. The size of a computing resource pool varies depending on the computing system, and may include hundreds or more of identical and/or different individual resources.

In a typical large-scale computing system, the computing resource pools are communicatively coupled with each other in a distributed network that is managed from a centralized computing management center. Examples of such centralized computing management centers include Utility Data Centers, Application Provider Centers, Internet Data Centers, and server farms.

Centrally managing computing resource pools in a network is desirable because of the many potentially realizeable benefits. For example, centrally managed computing resource pools can potentially result in more efficient use of computing resources; better availability of computing resources; more flexibility in allocating computing resources; lower computing resource costs; elimination of wasteful duplicative computing resources; sharing of computing resources by end-users, and other benefits.

Centrally managing computing resource pools, however, is technically complex, with success being dependent upon managing several key factors. One such key factor is the management of failed computing resources in the network. Another such key factor is the management of fluctuating demands for operating computing resources in the network within the constraints of a financial budget.

An operating computing resource is a computing resource that is specifically configured to operate in a computing system. It will be appreciated that, based on the need for resources in the computing system, a computing resource, e.g. a server, can be configured in a plurality of ways to operate in the computing system.

In the prior art, a typical method by which computing resources in a network are managed is to provide pools of preconfigured computing resources on standby for use in the event of a failure of an operating computing resource, or for use in the event of a surge in demand for additional operating computing resources. Thus, in the prior art, when there is a need for additional operating computing resources, the available preconfigured resources from standby is conveniently switched into operation to satisfy the need.

A problem with the prior method of using preconfigured computing resources on standby to manage computing resource capacity is that, since the resources on standby are preconfigured, the use of the preconfigured resources on standby is limited to applications compatible with the preconfigurations. Thus, for example, if an operating resource has failed and a preconfigured standby resource is not available for the failed resource in the standby computing resource pool, then the failure in the operating computing pool cannot be rectified by resorting to the standby computing resource pool. Similarly, if there is a surge in demand for computing capacity, and a suitable preconfigured standby resource is not available in the standby computing resource pool, the demand for capacity cannot be satisfied from the standby computing resource pool. Hence, in the prior art, the availability of preconfigured standby computing resources is of limited value in managing computing resources.

With the increasing complexity of distributed computing networks and the increasing cost of providing computing resources in such networks, there is a need for a more flexibility in managing available resources in the computing networks. Further, with the availability of new technologies to manage computing resources, e.g., Utility Data Center as discussed herein, there is a desire better ways to utilize the tools available with these technologies.

Accordingly, it is an objective of the present invention to provide for a better way to manage computing resources in a computing system.

### SUMMARY OF THE INVENTION

The invention, in one embodiment, is a computing resource management method comprising: establishing a pool of free computing resources in a computing system; selecting a free computing resource from the pool of free computing resources to replace an operating computing resource in the computing system; and configuring the selected free computing resource to operate in the computing system, after replacing the operating computing resource with the free computing resource in the computing system, wherein said free computing resources comprises resources not preconfigured for use in said computing system. In alternative embodiments, the invention pertains to a computing resource management system, and a computer-useable storage media embodying aspects of the computing resource management method.

### BRIEF DESCRIPTION OF FIGURES

The accompanying FIGS. 1-5 illustrate embodiments of the invention by way of example and not by way of limitation; they are incorporated herein and form a part of this specification. FIGS. 1-5 referred to herein should be understood as not being drawn to scale except if specifically noted.

FIG. 1 is a flow chart of a computing resource management method in accordance with an embodiment of the invention.

FIG. 2 is a flow chart of a computing resource management method in accordance with an embodiment of the invention.

FIG. 3 is a block diagram of a computing resource management system in accordance with an embodiment of the invention.

FIG. 4 is a block diagram of a computer system wherein embodiments of the present invention is useable.

FIG. 5 is a block diagram of an example of a Utility Data Center configuration wherein embodiments of the invention is useable.

### DESCRIPTION OF EMBODIMENTS OF THE INVENTION

Overview

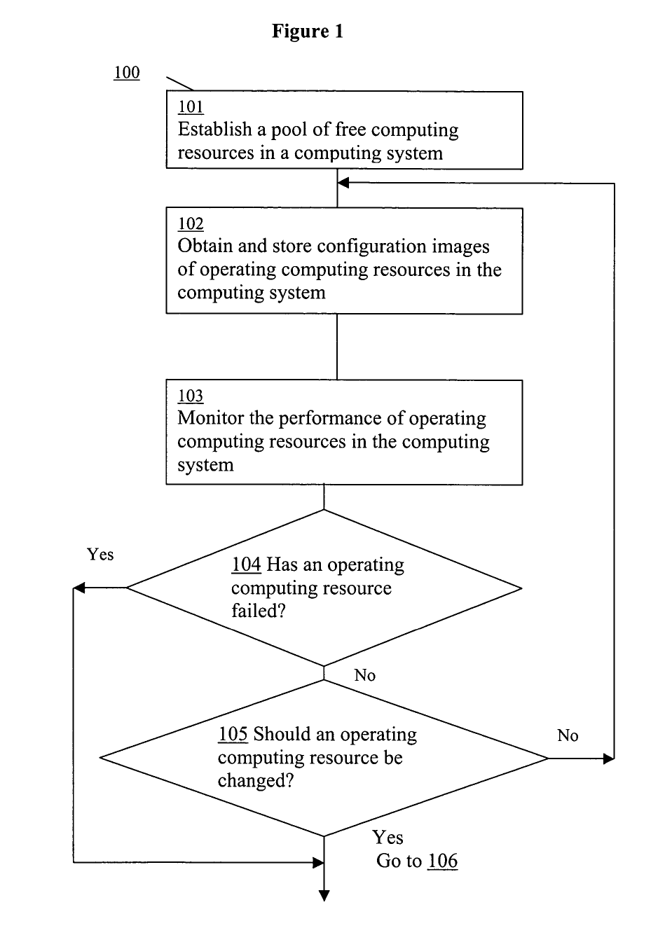

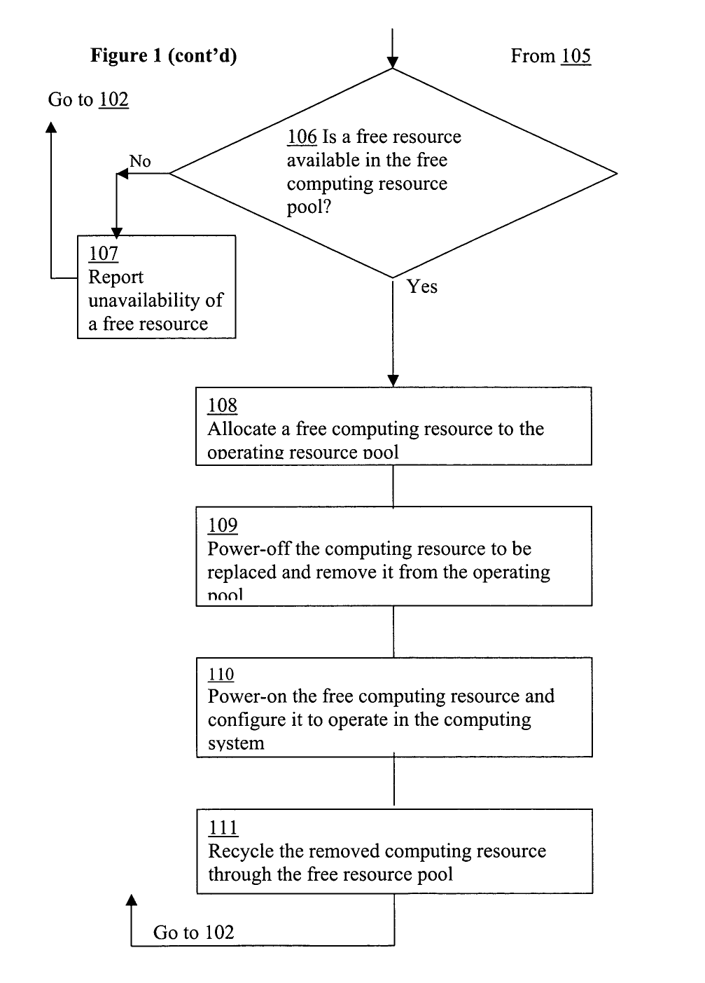

In overview and with reference to FIGS. 1-5, the present invention in various embodiments pertain to methods of managing computing resources that does not require preconfigured computing resources on standby, but instead uses a pool of free computing resources 304 from which operating computing resources 301 can be configured on-the-fly as needed. In accordance with embodiments of the invention 100, 200, 300 the free computing resources 304 are not configured for operation until after it has been determined that there is a need for a replacement computing resource in the operating computing resource pool 301.

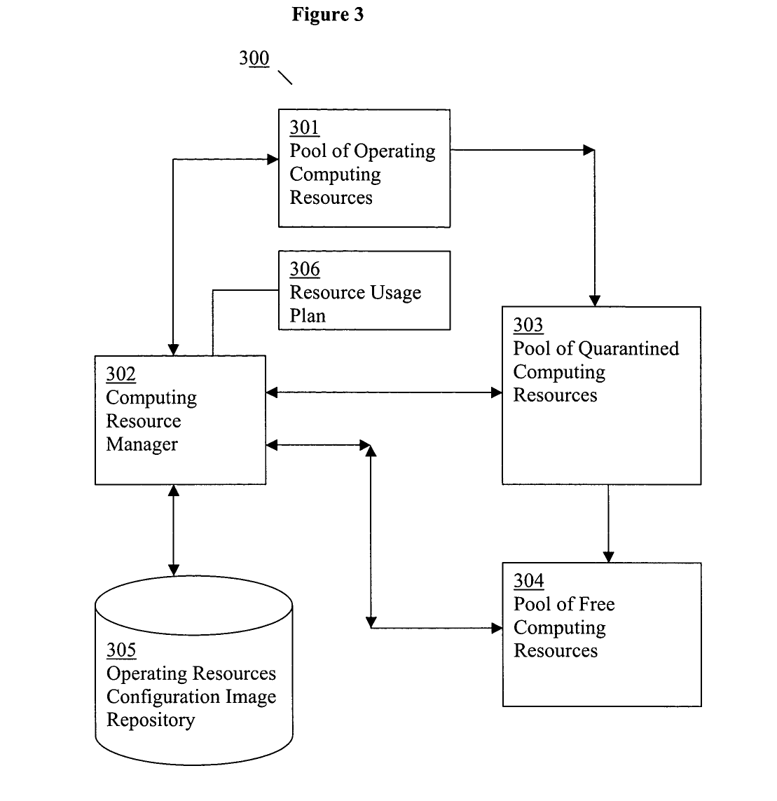

In one embodiment of the invention shown in computing resource system 300 of FIG. 3, an automated resource manager 302 is used to manage an operating computing resources pool 301 and a pool of free computing resources 304. A pool of free computing resources 304 is a collection of computing resources that are representative of the computing resources in operating computing resource pool 301 and are available for configuration for use in operating computing pool 301, but which are not configured for any application in operating computing resource pool 301 until a specific need arises.

In managing computing resource pools 301, 303, 304 in accordance with this embodiment, the resource manager 302 obtains and stores in configuration image repository 305, electronic copies (or images) of configurations of the operating computing resources in a computing in system e.g. 400, or a Utility Data Center 500. The electronic images are in computer-readable format and are stored for retrieval as needed to configure free computing resources 304 for use in the operating computing resource pool 301.

The resource manager 302 in accordance with this embodiment of the invention, on determining that there is need to replace a failed computing resource or to add resources to the operating computing pool 301 will query the free computing resources pool 304 to determine whether a suitable free resource is available for configuration to fill the need in the operating computing resource pool 301.

If a suitable free computing resource is available, the resource manager 302, in accordance with this embodiment of the invention, will virtually select and switch the free computing resource from the pool of free computing resource 304, to the operating computing resource pool 301. Simultaneously, the resource manager 302 will electronically retrieve a copy of an appropriate configuration image from the configuration image repository 305, power-on the free computing resource to be configured, and configure the free computing resource to operate in the operating computing resource pool 301.

Concurrently, if a failed computing resource is replaced in the operating computing resource pool 310, the resource manager 302, in accordance with this embodiment of the invention, will virtually power-off the failed computing resource and switch the failed computing resource to a pool of quarantined computing resources 303 for rehabilitation and subsequent recycling in the computing resource system 300.

If resource manager 302 on querying the pool of free computing resources 304, in accordance with this embodiment of the invention, cannot locate a suitable free computing resource for use in the operating computing pool 301, the resource manager 302 will communicate a message to the end-user.

Further, in one embodiment of the invention 300, if all the free computing resources 304 have been allocated and/or configured for use in the operating resource pool 301, optionally the resource manager 302 will virtually reallocate an operating computing resource, based on a resource usage plan 306, to another operating resource configuration. Alternatively, in one embodiment of the invention, the resource usage plan 306 will specify that at least one free computing resource is always available in the pool of free computing resources 304 for allocation to the operating computing resource pool 302.

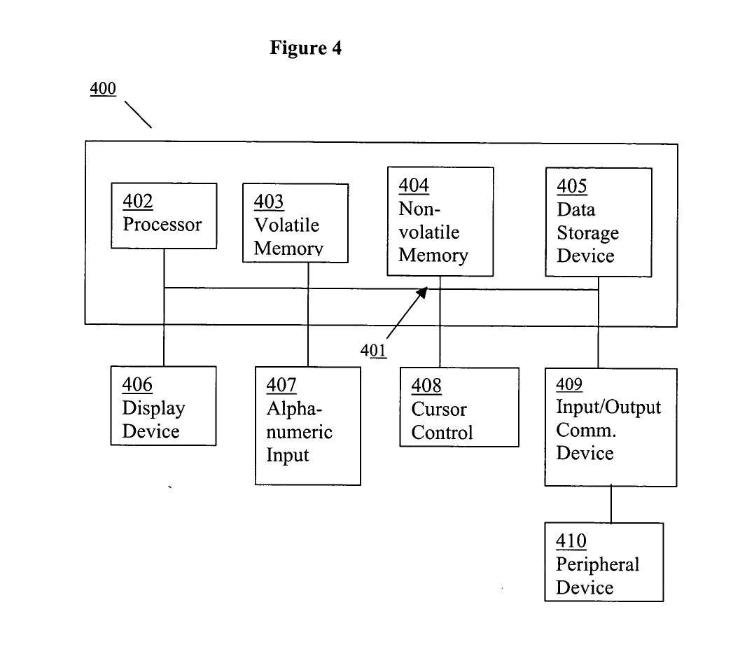

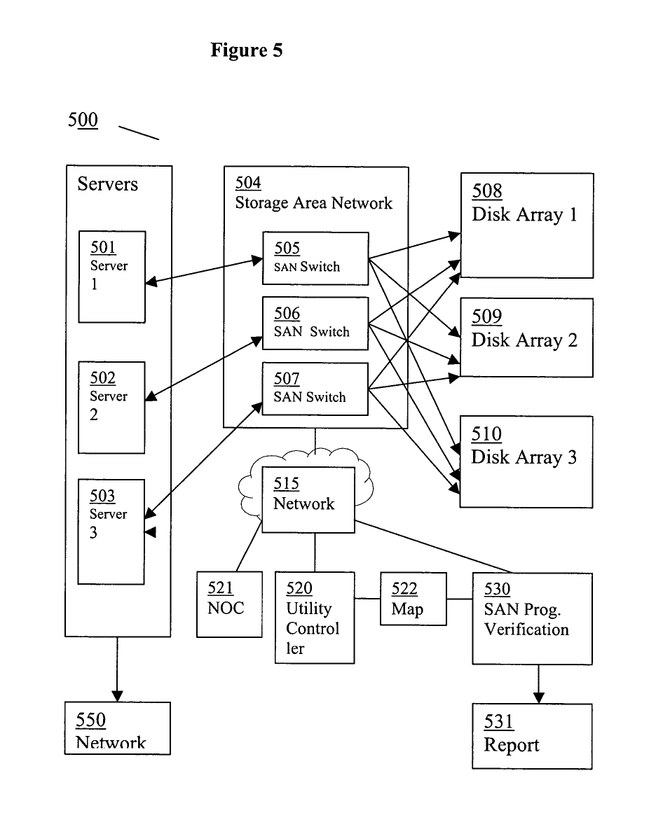

The functions performed by the resource manager 302 as set forth in the embodiment 300 shown in FIG. 3 are accomplished automatically, based on a computer-executable code embodied in computer software in a computer system, e.g., system 400 of FIG. 4 or Utility Data Center 500 of FIG. 5.

Thus, with various embodiments of the invention 100, 200, 300, since the free computing resources 304 are configured on-the-fly when needed, there is increased flexibility in managing the computing resources, e.g., in a network or computing system 400 or Utility Data Center 500 compared to the prior art. One advantage of this increased flexibility is that a series of operating computing resource 302 failures can be fixed without the need for an inventory of preconfigured computing resources on standby as in the prior art. Another advantage of the invention is that since the free computing resources 304 can be configured for multiple applications in the operating computing resource pool 301, the investment in resources in the free computing pool 304 is less compared to the prior art. Additionally, since embodiments of the invention 100, 200, 300 are implementable in distributed network management centers such as, for example, Utility Data Center 500 of FIG. 5, the invention can use up-to-date tools available in these network management centers, as described herein.

### DETAILED DESCRIPTION

Reference is now made to FIGS. 1-5 to describe in more detail, various embodiments of the invention. While the invention is described in conjunction with FIGS. 1-5, it is understood that the following description and FIGS. 1-5 are not intended to limit the invention to these embodiments. On the contrary, the invention is intended to cover alternatives, modifications and equivalents that are within the scope of the appended claims. Additionally, in the following description, although specific details of the invention are set forth, it is understood the invention may be practiced without all of these specific details. Further in the following description, generally known methods, procedures and equipment have not been described in detail as to avoid unnecessarily obscuring aspects of the invention.

Some portions of the detailed description that follows are presented in terms of procedures, logic blocks, processing, and other symbolic representations of operations on data bits within a computer memory. These descriptions and representations are the means generally used by those ordinarily skilled in the pertinent art to effectively convey the substance of their work to others ordinarily skilled in the art. A procedure, logic block, process, etc., is here generally conceived to be a sequence of steps or instructions that guide operations of a computer system to a desired result. The steps include physical manipulations of physical quantities. Usually, though not necessarily, these quantities take the form of electrical, magnetic, optical, laser or quantum signals capable of being stored, transferred, combined, compared, and otherwise manipulated in a computer processing system. It is convenient at times, principally for reasons of common usage, to refer to these signals as bits, values, elements, symbols, characters, terms, numbers, or the like. All of these and similar terms are associated with the appropriate physical quantities and are merely convenient labels applied to these quantities.

Unless specifically stated otherwise as apparent from the following discussions, it is appreciated that throughout the present description, discussions utilizing terms such as “establishing”, “selecting”, “configuring”, and the like, refer to the action and processes of a computer system, or similar processing device (e.g., an electrical, optical, or quantum computing device), that manipulates and transforms data represented as physical (e.g., electronic) quantities. The terms refer to actions and processes of the processing devices that manipulate or transform physical quantities within a computer system's components (e.g., registers, memories, other such information storage, transmission or display devices, etc.) into other data similarly represented as physical quantities within the same or other components.

Referring again to flow chart 100 of FIG. 1 and computing system 300 of FIG. 3, in one embodiment of the invention the method at step 101 comprises establishing a pool of free computing resources 304 in a computing system, e.g. computer system 400 of FIG. 4 or a Utility Data Center 500 of FIG. 5. A pool of free computing resources 304, as noted above, is a collection of computing resources that is representative of the resources in an operating computing resource pool 301 and which are available for configuration for use in the operating computing pool 301, but which are not configured for any specific application in the operating computing resource pool until a specific need arises. Examples of such free computing resources include servers, routers, data storage systems, load balancers, central processing units and the like.

In one embodiment of the invention as shown in computing system 300, the pool of free computing resources 304 is a component of a computing resource management system 300 that includes computing resource manager 302, operating resources configuration image repository 305, a pool of operating computing resources 301 and a pool of quarantined computing resources 303 as set forth in FIG. 3.

In step 102, configuration images of operating computing resources in computing system 300 are obtained and stored. The configuration images are electronic copies of configurations of operating computing resources in computing system 300. The images are in computer-readable format and are stored, for example, in configuration image repository 305 for retrieval as needed to configure a free computing resource 304 for use in the operating computing resource pool 304. The storage and retrieval of the images in one embodiment of the invention are managed by computing resource manager 302. Computing resource manager 302 in one embodiment is a computer-executable software program containing instructions for managing, inter alia, computing resources 301, 303 and 304 in computing system 300. Such instructions are programmable using well known techniques in the art.

In step 103, the performance of the operating computing resources 301 in computing system 300 is monitored. In one embodiment the monitoring is done electronically by resource manager 302 using computer-implementable electronic means well known in the art.

In step 104, if on monitoring the computing system 300 it has been determined that an operating resource in the pool of operating resources 301 has failed, resource manager 302, in step 106 will query free resource pool 304 to determine whether a suitable free resource is available in the free computing resource pool 304 to replace the failed operating resource.

Alternatively in step 105, if resource manager 302 has determined that an operating computing resource should be replaced in the operating resource computing pool 301 for reasons other than a failure, e.g., the resource is required for reconfiguration for another application in computing system 300 in accordance with a free computing resource usage plan 306, the resource manager 302 in step 106 will query the free computing resource pool 304 to determine whether a suitable free resource is available in free computing resource pool 304 to replace the replaced reconfigured operating resource. Computing resource usage plan 306 is an updateable plan that defines how computing resources in pools 301, 302 and 304 in computing system 300 are utilized under various operating scenarios. The computing usage plan 306 is implementable by computing resource manager 302 using established techniques well known in the art.

If in step 106 resource manager 302 cannot identify a free computing resource in the free computing resource pool 304 then in step 107 the unavailability of a free computing resource in system 300 is reported to the requester and the method 100 continues by returning to step 102.

If, however, in step 106 a compatible free computing resource is available, resource manager 302 in step 108 will allocate the identified compatible free computing resource from the free computing resource pool 304 to the operating computing resource pool 301. Thereafter in step 109, the resource manager 302 will power off the failed operating resource and relegate it to quarantined resource pool 303.

Continuing in step 110, resource manager 302 will power-on the free computing resource and configure the free resource in the computing resource system 300 with an operating resource configuration retrieved from the operating resources configuration image repository 305.

Subsequently in step 111, resource manager 302 will direct the failed operating computing resource to the pool of quarantined resources 303 for rehabilitation and subsequent reprovisioning into the free computing resource pool 304.

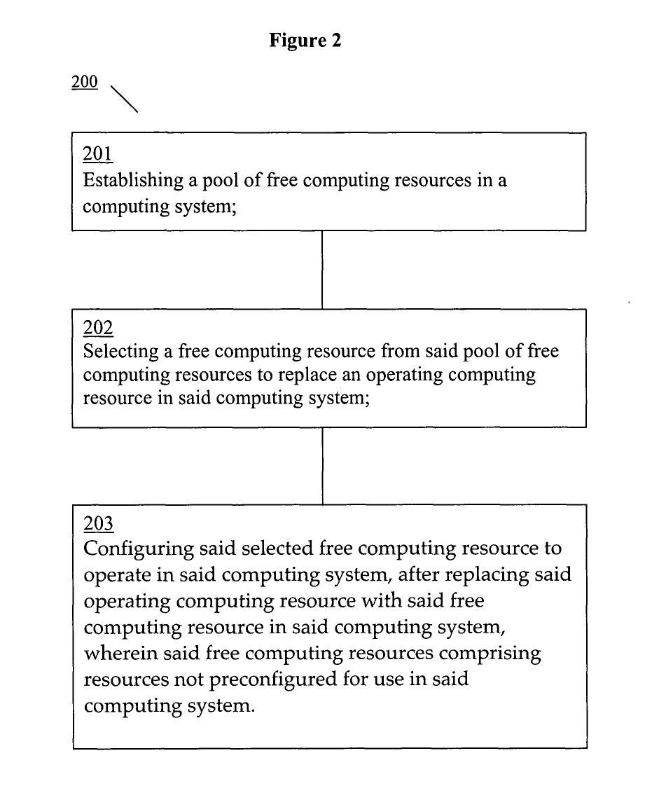

In another embodiment shown in flow chart 200 of FIG. 2, the invention is a computing resource management method comprising, in step 201, establishing a pool of free computing resources 304 in a computing system, e.g., system 400 of FIG. 4 or Utility Data Center 500 of FIG. 5. A pool of free computing resources 304, as described herein, is a collection of computing resources that are representative of the computing resources in the operating computing resource pool 301 and are available for configuration for use in the operating computing pool 301, but which are not configured for any specific application in the operating computing resource pool 301 until a specific need arises.

In step 202, a free computing resource is selected from the pool of free computing resources 301 to replace an operating computing resource 301 for example in computing system 400 or Utility Data Center 500. In one embodiment, the selection of the free computing resource is controlled by resource manager 302 based on a current need for resource in the operating computing resource pool 301, or based on instructions set forth in resource usage plan 306.

In step 203, the selected free computing resource of step 202 is configured to operate in the computing system 300, after replacing the operating computing resource with said free computing resource in computing system 300. The free computing resources comprises resources not preconfigured for use in computing system 300.

It should be noted that although specific steps of an embodiment of the invention are set forth in flowcharts 100 and 200, such steps are exemplary. That is, embodiments of the invention can be performed by various other steps or steps equivalent to those steps set forth in flowcharts 100 and/or 200. Also, the steps in flowcharts 100 and/or 200 may be performed in an order different than presented, and not all of the steps in flowchart 100 and/or 200 may be performed. All of, or a portion of, the method set forth in flowcharts 100 and/or 200 may be implemented using computer-readable and computer-executable instructions which reside, for example, in computer-usable media of a computer system 400 of FIG. 4, or Utility Data Center 500 of FIG. 5. In one embodiment, the steps of flowcharts 100 and/or 200 can be implemented by the exemplary computer system 400 of FIG. 4 and/or Utility Data Center 500 a described below.

Computer-Useable Storage Medium

In one embodiment, the invention comprises a method, as set forth for example in flow charts 100 and 200, comprising computer-readable program code embedded in a computer-useable storage medium for causing a computer system, for example computer system 400 of FIG. 4 and Utility Data Center 500 of FIG. 5 to implement a computing resource management method instructions issued by computing resource manager 302.

In one embodiment the program code includes: a resource manager software 302 module wherein the resource manager module includes instructions for monitoring a pool of free computing resources 304 in a computing system 400, 500; a software module means for selecting a selected free computing resource from the pool of free computing resources 304 to replace an operating computing resource in the computing system 400, 500; and a software module means for configuring the selected free computing resource 304 to operate in the computing system 400, 500 after replacing the operating computing resource with the selected free computing resource 304.

In this embodiment of the invention the software means for selecting a selected free computing resource from the pool of free computing resources 304 to replace an operating computing resource in the computing system 400, 500 and the software means for configuring the selected free computing resource 304 to operate in the computing system 400, 500 after replacing the operating computing resource with the selected free computing resource 304 are software functions and modules generally known and are available in the art.

Computing Resource Management System

In another embodiment, the invention comprises a computing resource management system 300 including a pool of free computing resource 304; a pool of operating computing resource 302; and means, e.g. computing resource manager 301, for selecting a selected free computing resource from the pool of free computing resources 304 to replace an operating computing resource a computing system e.g. computing system 400 or a Utility Data Center 500; and means, e.g., computing resource manager 302, for configuring the selected free computing resource 304 to operate in the computing system, e.g., computing system 400 or Utility Data Center 500, after replacing the first operating computing resource with said selected free computing resource.

Computer System for Utilizing Embodiments if the Invention

Reference is made to FIG. 4 in describing a computing system 400 wherein embodiments of the invention can be utilized. With reference to FIG. 4, embodiments of the invention comprise computer-readable and computer-executable instructions that reside, for example, in computer system 400 of FIG. 4. Computer system 400 may be a part of a general purpose computer network (not shown), or may be a stand-alone computer system. It will be appreciated that computer system 400 of FIG. 4 is exemplary only and that embodiments of the invention is implementable on different computer systems including general-purpose computer systems, embedded computer systems, laptop computer systems, hand-held computer systems, stand-alone computer systems and networked computer systems including the Internet.

In one configuration, computer system 400 includes an address/data bus 401 for conveying digital information between the various components, a central processor unit (CPU) 402 for processing the digital information and instructions, a volatile main memory 403 comprised of volatile random access memory (RAM) for storing the digital information and instructions, and a non-volatile read only memory (ROM) 404 for storing information and instructions of a more permanent nature. In addition, computer system 400 may also include a data storage device 405 (e.g., a magnetic, optical, floppy, semiconductor or tape drive or the like) for storing data. It should be noted that the software program for managing computing resources in according to the present invention in accordance with an embodiment can be stored either in volatile memory 403, data storage device 405, or in an external storage device (not shown).

Devices which are optionally coupled to computer system 400 include a display device 406 for displaying information to a computer user, an alpha-numeric input device 407 (e.g., a keyboard), and a cursor control device 408 (e.g., mouse, trackball, light pen, etc.) for inputting data, selections, updates, etc. Computer system 400 can also include a mechanism for emitting an audible signal (not shown). Optional display device 406 of FIG. 4 may be a liquid crystal device, cathode ray tube, or other display device suitable for creating graphic images and alpha-numeric characters recognizable to a user.

Computer system 400 can include an input/output (I/O) signal unit (e.g., interface) 409 for interfacing with a peripheral device 410 (e.g., a computer network, modem, mass storage device, etc.). Accordingly, computer system 400 may be coupled in a network, such as a client/server system, whereby a number of clients (e.g., personal computers, workstations, portable computers, minicomputers, terminals, etc.) are used to run processes for performing desired tasks (e.g., “establishing”, or “selecting,” or “configuring,” etc.). In particular, computer system 400 can be coupled in a system for executing a software application program that embodies aspects the present invention.

Utility Data Center for Utilizing Embodiments if the Invention

In the following description, reference is made to FIG. 5 in describing a Utility Data Center wherein embodiments of the present invention can be utilized. For the purpose of illustrating the use of the present invention in conjunction with a Utility Data Center (UDC), the following discussion will utilize block diagram 500 of FIG. 5.

FIG. 5 is an exemplary block diagram of a utility data center (UDC) 500 for implementing embodiments of the present invention. In FIG. 5, a UDC is shown as comprising a plurality of servers (e.g., servers 501, 502, and 503) coupled with a plurality of disk arrays (e.g., disk arrays 508, 509, and 510) via storage area network (SAN) 504. More specifically, SAN 504 comprises a plurality of SAN switches (e.g., SAN switches 505, 506, and 507) that communicatively couple servers 501, 502, and 503 with disk arrays 508, 509, and 510. The disk arrays may include hundreds or even thousands of individual disk drives. Servers 501, 502, and 503 are further coupled with network 550 which is, for example, an enterprise backbone, or the Internet.

UDC 500 includes a network operations center (NOC) 521 and a utility controller 520 that are coupled with SAN 504 via a network 515. NOC 521 provides for overall control of UDC 500. In one configuration, NOC 521 is manned by network technicians that monitor the management and allocation of resources in UDC 500. Network technicians may also install and/or repair physical resources in the pool of resources, or monitor the need for repair of physical resources after installation by the UDC supplier, and contact the appropriate support providers when appropriate. Also, NOC 521 acts as an interface between UDC 300 and a plurality of end users. NOC 521 can be coupled to the plurality of end users through the network 550.

Utility controller 520 manages the resources in the UDC 500. For example, utility controller 520 can enable the deployment, allocation, and management of computing resources in a network. One method for allocating resources in UDC 500 is the creation of computing resource pools. In this system computing resource pools are logical assemblies of computing resources that are virtually coupled and managed by the utility controller software to implement solution designs. Utility controller 520, for example, monitors deployed pools and automatically re-deploys (“re-provisions”) replacement resources from a free resource pool to a production resource pool if a operating pool failure is detected. The pools deployed with resources can be tailored to meet a wide variety of end-user needs. Each pool has its own dedicated computing, storage, and appliance resources. The pool can share common resources, such as storage and networking fabric, or can be managed as a plurality of networked pools within a larger enterprise network. In addition, utility controller 520 monitors shared infrastructure resources, alerting NOC 521 of failures or other significant events, such as, intrusion attempts.

In one configuration, UDC 500 can utilize a programmable computing resources for enabling the virtual connection of any network resource as well as the isolation of a set of network resources. The pool of resources in UDC 500 comprises a pre-wired, pre-integrated and pre-tested plurality of physical resources from which multiple pools can be created on demand. The resources include, but are not limited to, servers, switches, computers, appliances (e.g., load balancers and firewalls), storage arrays, and backup devices. For example, SAN 504 may include a plurality of SCSI-to-fiber converters, fiber channel hubs, fiber channel switches and fiber channel bridges. The resources in UDC 500 are physically pre-wired, pre-tested, and integrated (ideally a one-time wiring solution) and then dynamically, and logically re-wired into various virtual pool environments. The resources can also be logically re-wired using virtual local area network technology (VLAN), in one configuration. As such, UDC 500 can create and manage a plurality of virtual computing resource pools, each of which utilize a set of resources in UDC 500, or a plurality of networked pools within a larger enterprise network.

In one configuration, UDC 500 can support multi-vendor and open systems for a wide variety of computing resources. As such, UDC 500 can provide support to resources that have the same functionality (e.g., firewalls) but are provided by different vendors. Also, UDC 500 can support the various operating systems that each of those resources may use.

The foregoing descriptions of specific embodiments of the present invention have been presented for purposes of illustration and description. They are not intended to be exhaustive or to limit the invention to the precise forms described, and obviously many modifications and variations are possible in light of the above teaching. The embodiments were chosen and described in order to best describe the invention and its practical application. It is intended that the scope of the invention be defined by the claims appended hereto and their equivalents.

1. A computing resource management method comprising:
establishing a pool of free computing resources in a computing system;
selecting a free computing resource from said pool of free computing resources to replace an operating computing resource in said computing system; and
configuring said selected free computing resource to operate in said computing system, after replacing said operating computing resource with said free computing resource in said computing system, wherein said free computing resources comprises resources not preconfigured for use in said computing system.

2. The method of claim 1, wherein said selected free computing resource is configured to operate in accordance with a configuration of said operating computing resource being replaced.

3. The method of claim 1, wherein said selected free computing resource is not configured to operate in accordance with a configuration of said operating resource being replaced.

4. The method of claim 1, wherein said selecting and configuring said free computing resource is initiated automatically upon a failure of said operating computing resource in said computing system.

5. The method of claim 1, wherein said selecting and configuring said free computing resource is initiated in response to an end-user request for a changed operating computing resource in said computing system.

6. The method of claim 1, wherein said selecting and configuring of said free computing resource is based on a usage plan for using said free resources in said free pool of computing resources.

7. The method of claim 6, wherein said usage plan for using said free resources is implementable automatically in response to a failure of an operating computing resources in said computing system.

8. The method of claim 1, wherein said selecting and configuring said free computing resource to replace said operating computing resource occurs transparently to end-users in said computing system.

9. The method of claim 1, wherein said computing system comprises a Utility Data Center.

10. The method of claim 1, wherein said computing system comprises a computer network.

11. The method of claim 1, further including monitoring said computing system to detect failed operating computing resources.

12. The method of claim 11, further including relegating said failed operating computing resources to a pool of quarantined computing resources.

13. The method of claim 12, further including rehabilitating said failed operating computing resources for reprovisioning into said computing system.

14. The method of claim 1, wherein said computing resources comprises routers, servers, data storage systems and CPU's.

15. A computing resource management system comprising:
a pool of free computing resource in a computing system;
a pool of operating computing resource operating in said computing system; and
means for selecting a selected free computing resource from said pool of free computing resources to replace a first operating computing resource in said computing system; and
means for configuring said selected free computing resource to operate in said computing system after replacing said first operating computing resource with said selected free computing resource, wherein said free computing resources comprises resources not preconfigured for use in said computing system.

16. The computing resource management system of claim 15, wherein said means for configuring said selected free computing resource is operable to configure said selected free computing resource to operate in accordance with a configuration of said first operating resource being replaced.

17. The computing resource management system of claim 15, wherein said means for configuring said selected free computing resource is operable to configure said selected free computing resource not to operate in accordance with a configuration of said first operating resource being replaced.

18. The computing resource management system of claim 15, wherein said means for configuring said selected free computing resource is operable to automatically configure said selected computing resource to operate in said computing system upon a failure of said first operating computing resource in said computing system.

19. The computing resource management system of claim 15, wherein said means for configuring said selected free computing resource is operable to automatically configure said selected free computing resource in response to an end-user request for changing said first operating computing resource in said computing system.

20. The computing resource management system of claim 15, wherein said means for configuring said selected free computing resource is operable to configure said selected free computing resources transparently to an end-user in said computing system.

21. The computing resource management system of claim 15, wherein said means for configuring said selected free computing resources is operable to configure said selected free computing resources based on a usage plan for using said free computing resources in said free computing resource pool.

22. A computer-useable storage medium comprising computer-readable program code embodied therein for causing a computer system to implement a computing resource management method instructions, said program code including a resource manager module, said resource manager module comprising instructions for:
monitoring a pool of free computing resources in a computing system;
selecting a selected free computing resource from said pool of free computing resources to replace an operating computing resource in said computing system; and
configuring said selected free computing resource to operate in said computing system after replacing said operating computing resource with said selected free computing resource, wherein said free computing resources comprises resources not preconfigured for use in said computing system.

23. The computer-useable storage medium of claim 22, wherein said resource manager module includes instructions for monitoring said operating computing resources in said computing system.

24. The computer-useable storage medium of claim 22, wherein said resource manager module includes instructions for detecting failures of said operating computing resource in said computing system.

25. The computer-useable storage medium of claim 22, wherein said resource manager module includes instructions for configuring said selected free computing resource to operate in accordance with a configuration of said operating computing resource being replaced.

26. The computer-useable storage medium of claim 22, wherein said resource manager module includes instructions for configuring said selected free computing resource not to operate in accordance with a configuration of said operating resource being replaced.

27. The computer-useable storage medium of claim 22, wherein said resource manager module includes instructions for selecting and configuring said free computing resource automatically upon detecting a failure of said operating computing resource in said computing system.

28. The computer-useable storage medium of claim 22, wherein said resource manager module includes instructions for selecting and configuring said free computing resource based on an end-user request for operating computing resource in said computing system.

29. The computer-useable storage medium of claim 22, wherein said resource manager module includes instruction for selecting and configuring said free computing resource transparently to an end-user in said computing system.

30. The computer-useable storage medium of claim 22, wherein said resource manager module includes instruction for selecting and configuring said free computing resource based on a usage plan for using computing resources from said free computing resources pool.
